(19) United States
(12) Patent Application Publication
(10) Pub. No.: US 2013/0067378 A1
(43) Pub. Date: Mar. 14, 2013

(54) Resource Usage History User Interface

(71) Applicants: Jonathan M. Au, Redmond, WA (US); Peter Seraphim Ponomarev, Seattle, WA (US); Sharif S. Farag, Bothell, WA (US); Kevin Michael Woley, Seattle, WA (US); Sharad Kylasam, Seattle, WA (US); Mark Yalovsky, Seattle, WA (US); Krishna Venkatesh, Seattle, WA (US); Shankar Seal, Bothell, WA (US); Srinivas Raghu Gatta, Redmond, WA (US); Rajeev Agrawal, Bothell, WA (US); Vijay Prakash, Seattle, WA (US)

(72) Inventors: Jonathan M. Au, Redmond, WA (US); Peter Seraphim Ponomarev, Seattle, WA (US); Sharif S. Farag, Bothell, WA (US); Kevin Michael Woley, Seattle, WA (US); Sharad Kylasam, Seattle, WA (US); Mark Yalovsky, Seattle, WA (US); Krishna Venkatesh, Seattle, WA (US); Shankar Seal, Bothell, WA (US); Srinivas Raghu Gatta, Redmond, WA (US); Rajeev Agrawal, Bothell, WA (US); Vijay Prakash, Seattle, WA (US)

(73) Assignee: Microsoft Corporation, Redmond, WA (US)

(21) Appl. No.: 13/229,592

(22) Filed: Sep. 9, 2011

(51) Int. Cl. G06F 3/048

(52) U.S. Cl. 715/771

(57) ABSTRACT

Various embodiments provide a user interface that displays a history of resource usage of a computing device's applications over time. Historical resource usage data can be presented in a manner which informs the user, on an application-by-application basis, of each application's resource usage across a plurality of resources. In at least some embodiments, the user interface can provide one or more instrumentalities that enable the user to interact with and/or modify operational characteristics of various applications based upon the presented historical resource usage data.

### BACKGROUND

When users use a computer or a mobile device, they often run a number of different applications. Over time, these applications use resources in ways that the user does not necessarily have visibility into. As a result of this usage, the user can experience various effects and may not understand which applications have contributed to the effects and to what extent these applications have caused the effects.

These effects can be manifest in a number of ways such as impacting a device's battery life, or affecting network usage. For example, if the device is on a metered usage plan and has exceeded the metered bandwidth limit, often times a user has no way to ascertain how much each particular application contributed to the metered bandwidth usage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide a user interface that displays a history of resource usage of a computing device's applications over time. Historical resource usage data can be presented in a manner which informs the user, on an application-by-application basis, of each application's resource usage across a plurality of resources. In at least some embodiments, the user interface can provide one or more instrumentalities that enable the user to interact with and/or modify operational characteristics of various applications based upon the presented historical resource usage data. Thus, having an element of control over applications can lead to efficiencies which enhance the user experience by enabling the user to control or influence, on application-by-application basis, resource consumption on their device.

In at least some embodiments, user controllability is enhanced by enabling the user to define a time window over which resource usage data can be presented.

In at least some embodiments, the user interface employs a heat map having multiple shades or colors that are used to abstract resource usage. The heat map allows for quick visual identification of resources and their particular usage on an application-by-application basis.

### BRIEF DESCRIPTION OF THE DRAWINGS

FIG. 1 is an illustration of an environment in an example implementation in accordance with one or more embodiments.

FIG. 2 is an illustration of a system in an example implementation showing FIG. 1 in greater detail.

FIG. 3 illustrates an example user interface in accordance with one or more embodiments.

FIG. 4 illustrates an example user interface in accordance with one or more embodiments.

FIG. 5 illustrates an example user interface in accordance with one or more embodiments.

FIG. 6 illustrates an example user interface in accordance with one or more embodiments.

FIG. 7 illustrates an example user interface in accordance with one or more embodiments.

FIGS. 9-13 illustrate flow diagrams that describe steps in various methods in accordance with one or more embodiments.

FIG. 14 illustrates an example computing device that can be utilized to implement various embodiments described herein.

### DETAILED DESCRIPTION

### Overview

Various embodiments provide a user interface that displays a history of resource usage of a computing device's applications over time. Historical resource usage data can be presented in a manner which informs the user, on an application-by-application basis, of each application's resource usage across a plurality of resources. Historical resource usage can be represented in any suitable way. For example, resource usage can be presented as a cumulative sum total over a given time window. Alternately or additionally, resource usage can be presented as a list of separate, distinct historical data points. Alternately or additionally, resource usage can be presented as a trend of usage over time, to name just a few. Any suitable type of resources can be monitored such that their associated usage data can be presented in the user interface. Such resources include, by way of example and not limitation, metered bandwidth, network type resources such as notification-related bandwidth and background downloads, CPU usage, resource usage associated with operating system processes at various levels of granularity, power impact, memory usage, application up time, disk resources, upload resources, and the like.

In at least some embodiments, the user interface can provide one or more instrumentalities that enable the user to interact with and/or modify operational characteristics of various applications based upon the presented historical resource usage data. Thus, having an element of control over applications can lead to efficiencies which enhance the user experience by enabling the user to control or influence, on application-by-application basis, resource consumption on their device.

In at least some embodiments, user controllability is enhanced by enabling the user to define a time window over which resource usage data can be presented.

In at least some embodiments, the user interface employs a heat map having multiple shades or colors that are used to abstract resource usage. The heat map allows for quick visual identification of resources and their particular usage on an application-by-application basis. Alternately, in the absence of a heat map, a table of data may be used.

In the following discussion, an example environment is first described that is operable to employ the embodiments described herein. The various embodiments may be employed in the example environment, as well as in other environments, as will become apparent below. Accordingly, the described embodiments are not limited the example environments described herein.

Example Environment

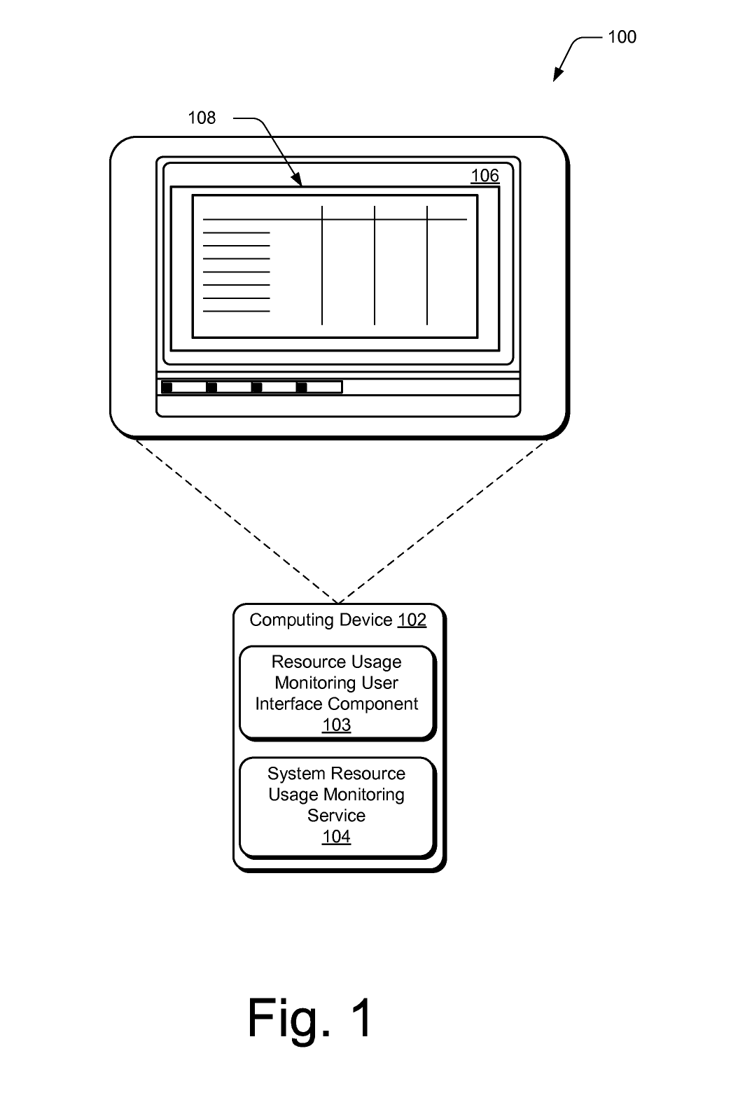

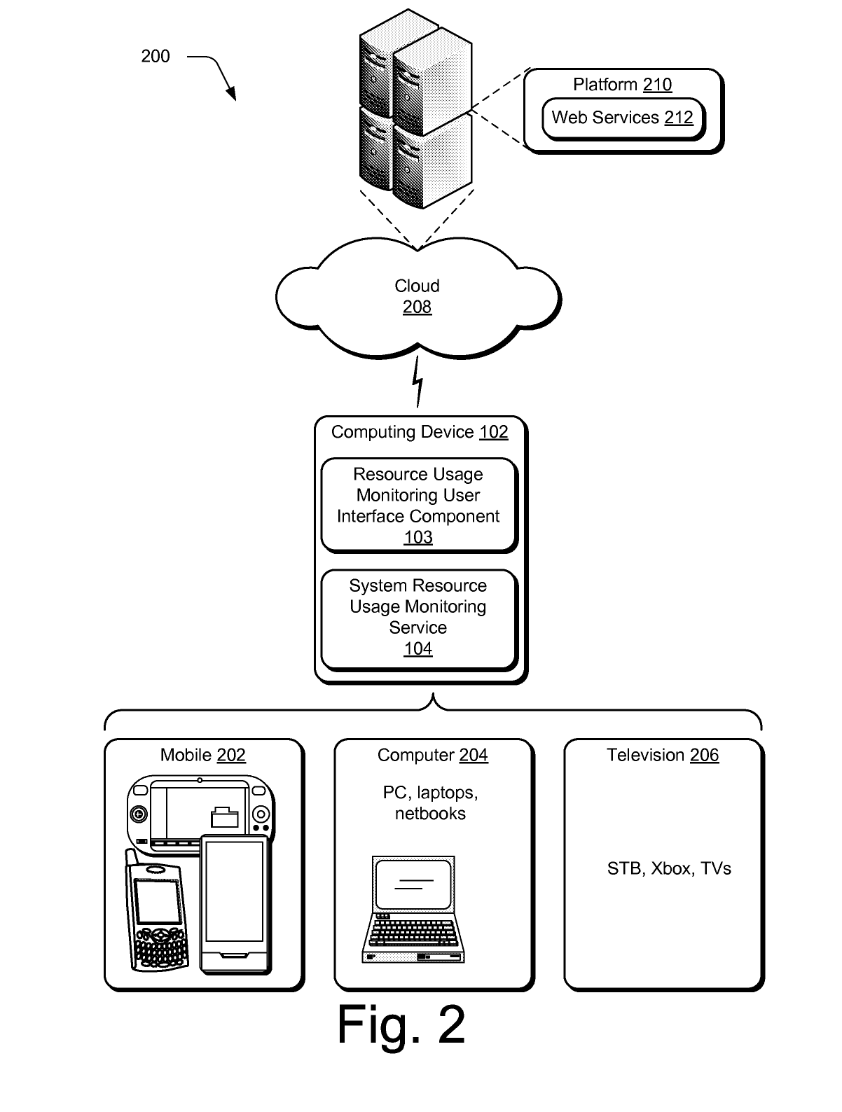

FIG. 1 is an illustration of an environment 100 in an example implementation that is operable to employ the various embodiments described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a resource usage monitoring user interface component 103 and a system resource usage monitoring service 104 that are operational to provide the functionality as described in this document. The user interface component 103 and monitoring service 104 can be implemented in connection with any suitable type of hardware, software, firmware or combination thereof. In at least some embodiments, the user interface component 103 and monitoring service 104 are implemented in software that resides on some type of tangible, computer-readable storage medium examples of which are provided below.

Computing device 102 includes a display screen 106 that may or may not be configured to receive physical input, e.g., touch input or stylus input. Display screen 106 can be utilized to present a resource usage history user interface 108 under the influence of resource usage monitoring user interface component 103.

Resource usage monitoring user interface component 103 is representative of functionality that provides a user interface that displays a history of resource usage of a computing device's applications over time. The user interface presents historical resource usage data in a manner which informs the user, on an application-by-application basis, of each application's resource usage across a plurality of resources such as, by way of example and not limitation, metered bandwidth, network type resources such as notification-related bandwidth and background downloads, CPU usage, resource usage associated with operating system processes at various levels of granularity, power impact, memory usage, and the like, as will become apparent below. The user interface component 103 can cause presentation of a user interface that, in some embodiments, can provide one or more instrumentalities that enable the user to interact with and/or modify operational characteristics of various applications based upon the presented historical resource usage data. This gives the user an element of control over applications which, in turn, can lead to efficiencies which enhance the user experience by enabling the user to control or influence, on application-by-application basis, resource consumption on their device. In some embodiments, application settings can be available from the same view, thus allowing users to modify settings as desired, e.g., modifying whether an application downloads tile information, receives various updates, or synchronizes over a mobile network. Further, in at least some embodiments, user controllability is enhanced by enabling the user to define, via the user interface, a time window over which resource usage data can be presented. Further, in at least some embodiments, the user interface employs a heat map having multiple shades or colors that are used to abstract resource usage. The heat map allows for quick visual identification of resources and their particular usage on an application-by-application basis.

System resource usage monitoring service 104 is representative of functionality that monitors individual resources, collects historical resource usage data associated with the resources, and stores the historical resource usage data in a database for subsequent access by the resource usage monitoring user interface component 103. The monitoring service 104 includes a set of consumer application program interfaces (APIs) that can be utilized by the user interface component to access the historical resource usage data for subsequent presentation via the user interface.

FIG. 2 illustrates an example system showing user interface component 103 and monitoring service 104 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

Generally, any of the functions described herein can be implemented using software, firmware, hardware (e.g., fixed logic circuitry), manual processing, or a combination of these implementations. The terms “module,” “functionality,” “component” and “logic” as used herein generally represent software, firmware, hardware, or a combination thereof. In the case of a software implementation, the module, component, functionality, or logic represents program code that performs specified tasks when executed on or by a processor (e.g., CPU or CPUs). The program code can be stored in one or more computer readable memory devices. The features of the resource monitoring techniques described below are platform-independent, meaning that the techniques may be implemented on a variety of commercial computing platforms having a variety of processors.

In the discussion that follows, various sections describe the operation of user interface component 103 and monitoring service 104, and provide examples of a resource usage history user interface. A section entitled “Resource Usage History User Interface” describes example interfaces in accordance with one or more embodiments. Next, a section entitled “System Resource Usage Monitoring Service” describes an example system or architecture that can be utilized to implement the functionality described herein. Following this, a section entitled “Example Methods” describes example methods in accordance with one or more embodiments. Last, a section entitled “Example Device” describes aspects of an example device that can be utilized to implement one or more embodiments.

Resource Usage History User Interface

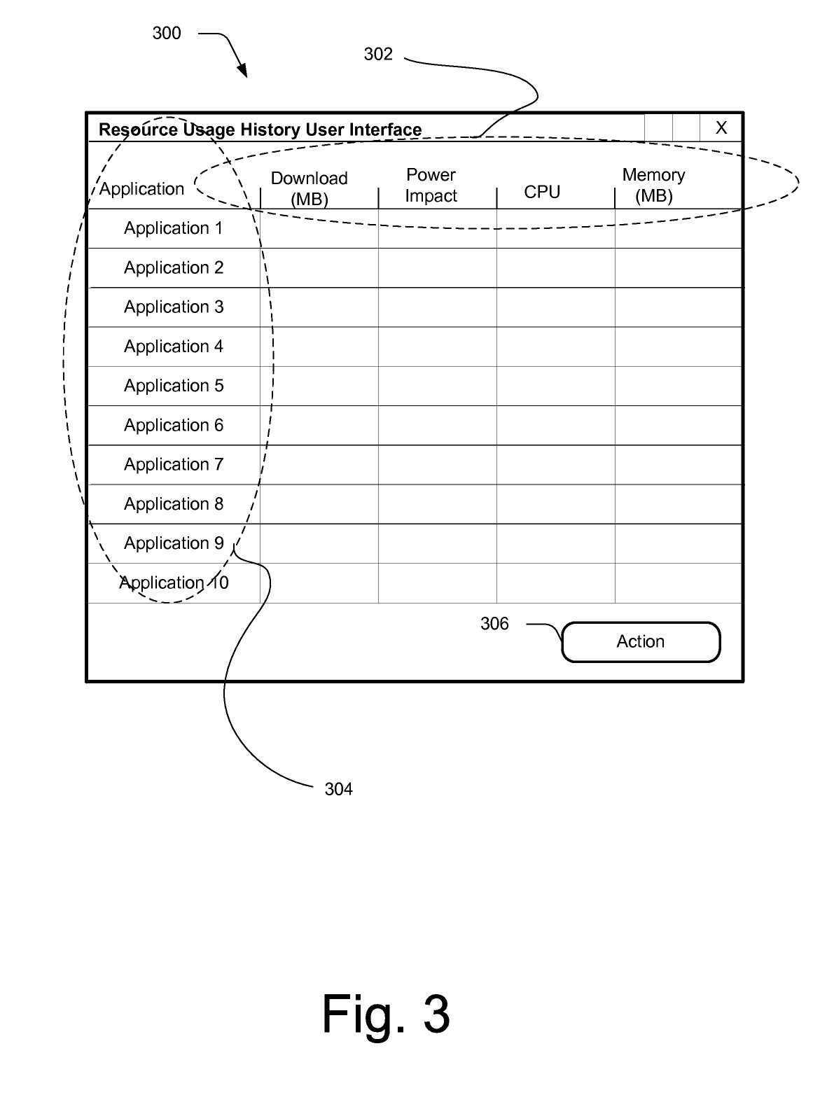

FIG. 3 illustrates an example user interface 300 that can be provided under the influence of resource usage monitoring user interface component 103 (FIG. 1), in accordance with one or more embodiments. In this particular example, a user interface portion 302 displays a listing of multiple different resources. In this particular example, the resources include download resources, power resources, CPU resources, and memory resources. It is to be appreciated and understood that while four different resources are shown, any number of resources can be displayed. For example, user interface 300 can be pannable to expose even more resources. In addition, a user interface portion 304 includes a listing of applications that can potentially use and/or impact usage of the resources displayed in user interface portion 302. Any suitable number of applications can be displayed. For example, user interface 300 can be scrollable to expose even more applications. In addition, while user interface portion 304 includes a listing of applications, it is to be appreciated and understood that other types of resource-impacting entities can be displayed and monitored without departing from the spirit and scope of the claimed subject matter. For example, individual processes or sub-components of individual applications could be displayed. Alternately or additionally, processes or groups of processes associated with an operating system can be displayed in user interface portion 304. Varying levels of granularity can be utilized to display resource usage impact of an operating system. For example, groupings of operating system components such as “desktop”, “display”, and/or “memory manager” can be listed in the user interface portion 304 and tracked, to name just a few.

In addition, in one or more embodiments the user interface 300 can include one or more action buttons an example of which is shown at 306. The action button or buttons can be utilized to enable the user to perform a particular action through the user interface 300. Thus, the action button or buttons can be utilized to enable the user to have an ability to have an element of control over their applications or processes. Any suitable type of action or actions can be performed, examples of which are provided below.

In the illustrated and described embodiment, each listed resource is given its own column and each listed application is given its own row. The intersection of a row and column defines a cell within which parameter values can be reported for an individual application's usage of a particular resource. Collectively, the reported parameter values can provide visibility into resource usage on an application-by-application basis, as will become apparent below. Any suitable type of parameter values can be utilized. For example, parameter values in the form of character strings, such as numbers or text, can be utilized. Alternately or additionally, parameter values in the form of visually discernible indicia that do not necessarily include numbers or text can be utilized. Examples of parameter values are provided below.

With respect to historical resource usage of various applications, consider the following. In at least some embodiments, resource utilization of an application can be either an indirect usage or a direct usage.

With respect to indirect resource usage, consider the following. Merely by virtue of the fact that an application is running on a computing device, the overall computing device or system may have to perform some additional work such as, by way of example and not limitation, downloading some particular content or consuming CPU time. In these instances, the application did not directly utilize the resource, but rather caused the resource to be utilized by the system. These indirect usages can be monitored and reported by way of user interface 300.

With respect to direct resource usages, consider a calendar application that performs a large number of tile updates. In this instance, the application is directly utilizing resources which, in turn, can be reported by way of user interface 300.

User-Controllable Time Window

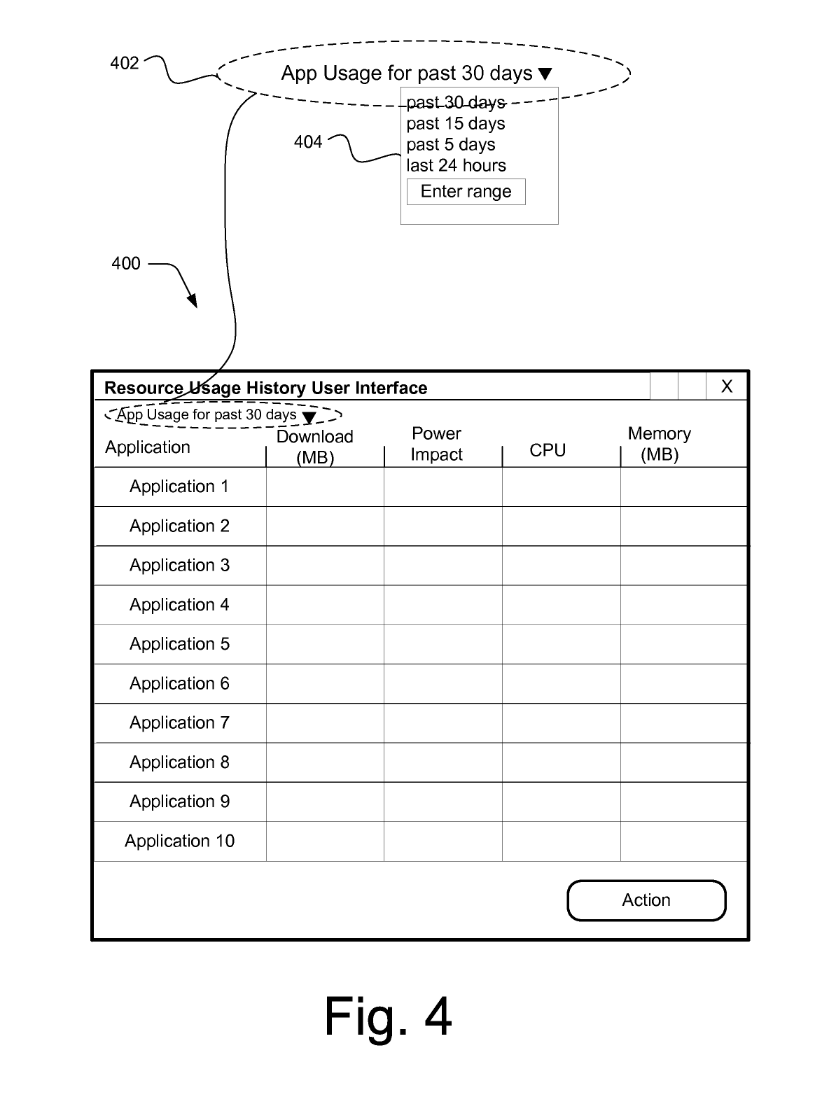

FIG. 4 illustrates an example user interface in accordance with one or more embodiments generally at 400. User interface 400 is similar, in some respects, to the user interface described in FIG. 3. In this particular example, however, user interface 400 includes a user-controllable time window, shown in enlarged form at 402. The user-controllable time window enables the user to define a time period over which resource usage data is displayed within individual cells of the user interface 400. Any suitable type of interface instrumentality can be utilized to enable a user to define a time period. For example, instrumentalities in the form of sliders and other mechanisms can be used. The slider can be used, for example, to enable adjustment of the beginning and/or end of a particular time window. In this particular example, a drop-down menu or instrumentality 404 enables the user to define the time period over which resource usage data is reported.

In this particular example, a number of pre-defined time periods are provided and are selectable by a user, e.g., “past 30 days”, “past 15 days”, “past 5 days”, and “last 24 hours”. In addition, a field “Enter range” is provided that enables the user to provide their own time period or range. For example, the user may be interested in a particular date range that can be entered into the field. Alternately or additionally, data can be maintained for past periods to enable such things as review and auditing. Further, rolling windows of time periods can be provided such that the user can set logs to be collected and reset every x days. In one or more embodiments, a user can thus define log periods, reset the time window and can use the time window to schedule resource monitoring.

Example User Interface—Parameter Value Examples

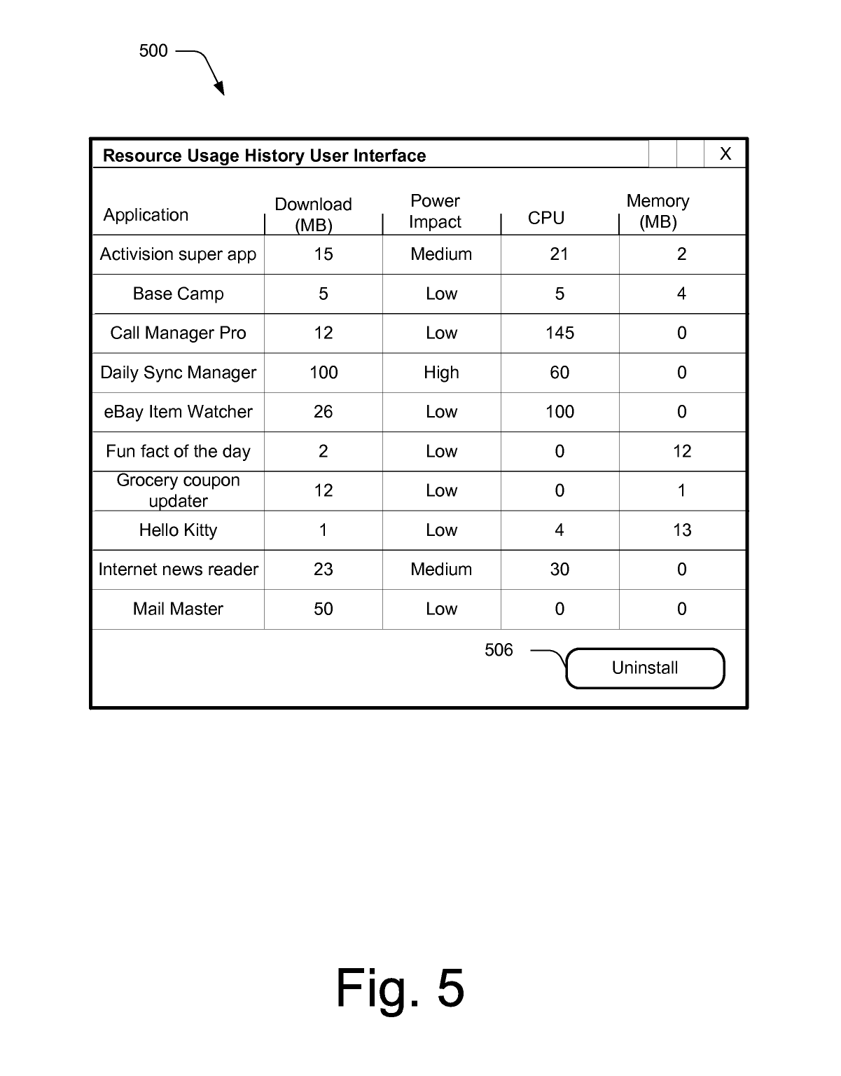

FIG. 5 illustrates a user interface in accordance with one or more embodiments generally at 500. In this particular example, individual specific applications are listed along with example parameter values describing resource usage of a particular resource. As noted above, the parameter values can assume any suitable form including, by way of example and not limitation, character strings or other visually discernible indicia. In this example, the parameter values include both numbers and textual descriptions, e.g., “low”, “medium”, and “high”. The numbers can describe actual values of amounts of a particular resource that have been utilized, e.g., 15 MB of download resource. Alternately or additionally, the numbers can describe percentages of resource usage.

Note in this particular example that an action button 506 is provided in the form of a “uninstall” action button. As noted above, the action buttons provide the user with an ability to have an element of control over their particular applications. For example, here a user can select a particular application by clicking on it and, subsequently, by clicking on action button 506, can have the application uninstalled. Alternately or additionally, other action buttons that provide other types of functionality can be provided. For example, action buttons can enable the user to not only uninstall applications, but to modify the performance of a particular application based on the displayed information in the user interface. Thus, a user might opt to open a particular application's settings to adjust the application's behavior responsive to ascertaining that application's resource usage.

It is to be appreciated and understood that an application's settings can be accessed in other ways without departing from the spirit and scope of the claimed subject matter. For example, in at least some embodiments an application's settings or a sub-collection of an application's settings can be accessed in-line via the user interface. Thus, an application's settings or sub-collection thereof can, in at least some embodiments, be accessed through an individual cell of the user interface, through a text menu by right-clicking on a particular selection, via a button that is presented after selecting a particular application, or a link that navigates directly to the settings or sub-collection thereof, to name just a few.

Network Type Behavior

In one or more embodiments, the user interface can be utilized to report resource usage associated with network type behavior. Resource usage associated with network type behavior can be reported at any suitable level of granularity. For example, network behavior can be broken down into individual components such as, by way of example and not limitation, “metered bandwidth”, “updates”, “notification-related bandwidth”, “background downloads”, and the like. Each of these particular components would, in at least some embodiments, have its own associated column in the user interface. Any suitable type of parameter value can be utilized to report resource usage information.

Using a Heat Map to Represent Resource Usage

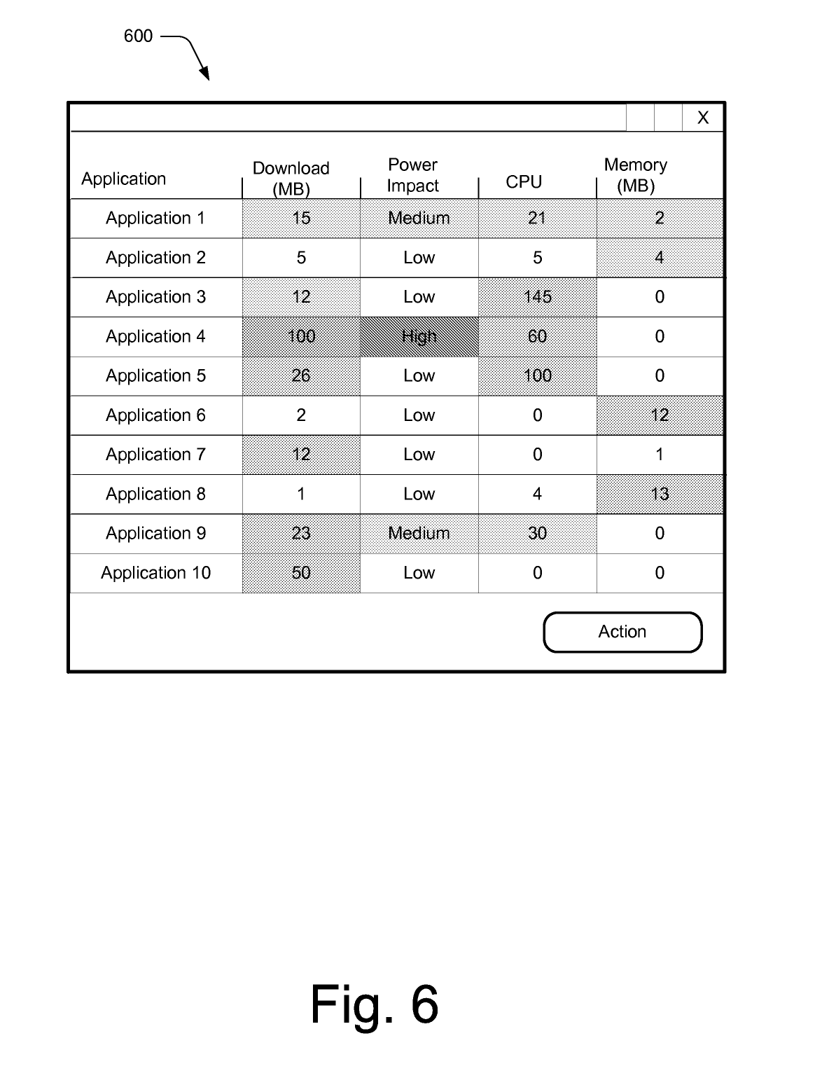

In one or more embodiments, a heat map can be utilized, either by itself, or in connection with other resource usage data, to abstract historical resource usage on an application-by-application basis. A heat map is a graphical representation of data where the values taken by a variable are represented as “intensities” (i.e. a combination of decreasing luminosity and increasing saturation). This can be visually manifest by different colors or shades. As an example, consider FIG. 6, which illustrates an example user interface, in accordance with one or more embodiments, generally at 600. In this particular example, a heat map is used to represent resource usage values that appear within individual cells. For example, values that are higher are represented by darker colors or shades. Notice, for example, that the power impact of Application 4 is given the darkest color or shade to reflect its “high” impact on power usage. Conversely, the memory usage of Application 3 is given the lightest color or shade to reflect its lack of impact on the memory resource. Any suitable number of colors or shades can be utilized.

Note that in the absence of a heat map, a table of data can be utilized to convey the same or similar data.

Presenting Additional Information

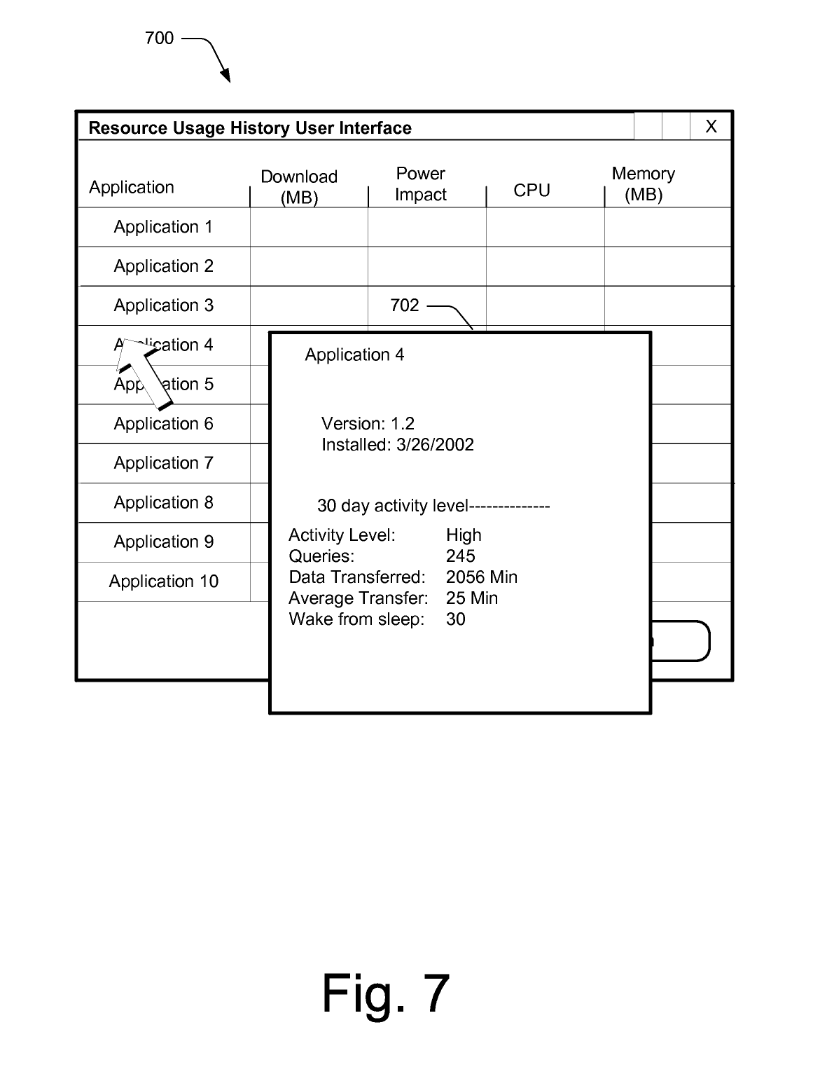

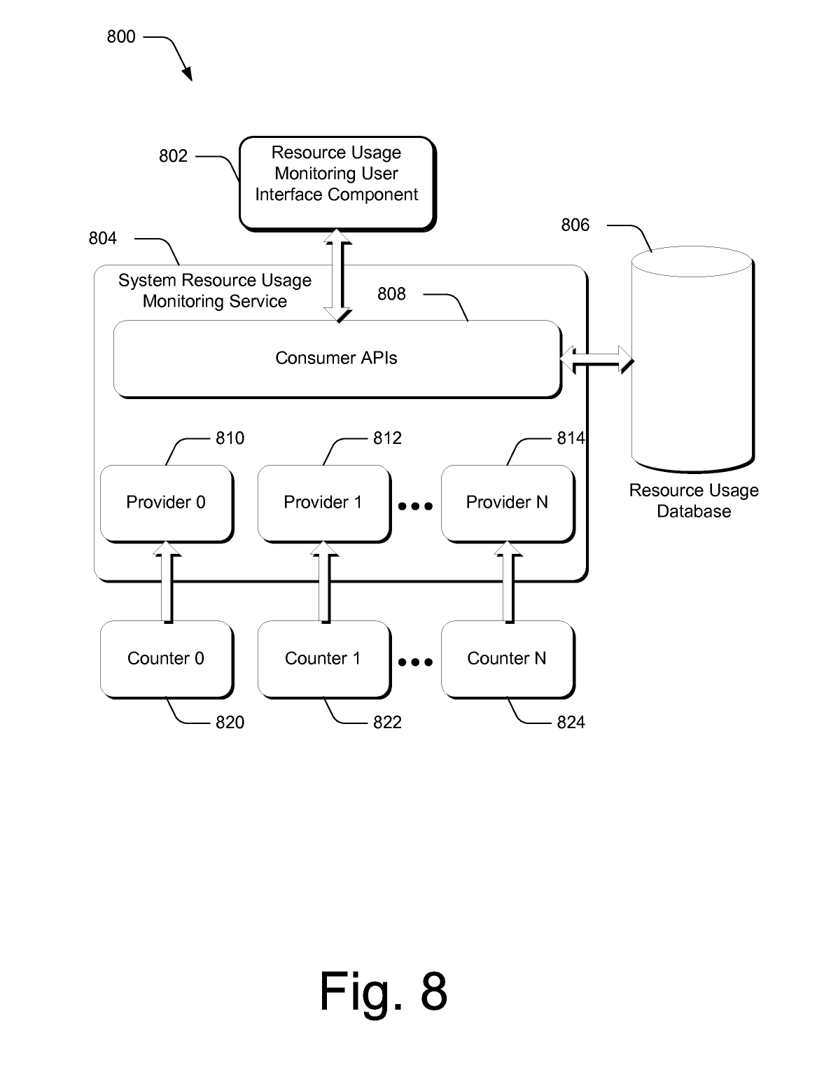

In one or more embodiments, the user interface can be utilized to present additional information associated with an application's resource usage. As an example, consider FIG. 7 which illustrates an example user interface in accordance with one or more embodiments generally at 700. In this particular example, a user has click-selected Application 4 and, responsively, a window 702 has been presented. Windows 702 includes additional information associated with this application. For example, the window includes version and installation date information, as well as additional information associated with this application's activity level. Any suitable type of additional information can be presented. In addition, any suitable user interface mechanism can be utilized to present this additional information. For example, each cell that includes an application's name can include a drop-down menu that can enable user to access this additional information.

In addition, in at least some embodiments, window 702 can be utilized to enable the user to access various actions that can be performed relative to the application. For example, such actions can include, by way of example and not limitation, uninstalling an application and/or modifying individual application settings.

Having considered various examples of user interfaces in accordance with one or more embodiments, consider now a discussion of a system resource usage monitoring service, such as that described in FIG. 1 at 104.

System Resource Usage Monitoring Service

As noted above, the system resource usage monitoring service provides functionality that monitors individual resources, collects historical resource usage data associated with the resources, and stores the historical resource usage data in a database for subsequent access by the resource usage monitoring user interface component. Any suitable type and/or architecture of a resource usage monitoring service can be employed. As but one example, consider FIG. 8.

There, a system in accordance with one or more embodiments is shown generally at 800. System 800 can be implemented in connection with any suitable hardware, software, firmware, or combination thereof In at least some embodiments, system 800 is implemented in software that resides on some type of computer readable storage medium.

System 800 includes, in this example, a resource usage monitoring user interface component 802, a system resource usage monitoring service 804, and a resource usage database 806.

The resource usage monitoring user interface component 802 behaves as described above. Specifically, this component is configured to enable presentation of a suitably-configured user interface that presents historical resource usage data as described above.

The system resource usage monitoring service 804 includes, in this example, a set of consumer application program interfaces (APIs) and multiple providers 810, 812, and 814. A set of counters 820, 822, and 824 is provided. Each counter is configured to monitor or collect resource usage data for individual resources in a computing device. In one or more embodiments, each counter is associated with a particular column that appears in the user interface described above. As the counters 820, 822, 824 collect resource usage data, the counters provide this data to an associated provider 810, 812, 814, respectively. The providers can be considered as abstractions that handle a particular type of data associated with resource usage. The providers cause the resource usage data to be stored in resource usage database 806. In at least some embodiments, the resource usage data is stored in associated tables that allow for quick, query-able access.

To access the historical resource usage data, the resource usage monitoring user interface component 802 utilizes the consumer APIs 808 and makes calls into the APIs to retrieve associated data that is to be populated in a suitably-configured user interface, such as the user interface described above.

It is to be appreciated and understood that the various interface features described above can be utilized together and combined in any suitable fashion. Thus, for example, the time window of FIG. 4 can be combined with the heat map feature of FIG. 6.

Having considered an example system resource usage monitoring service, consider now example methods in accordance with one or more embodiments.

Example Methods

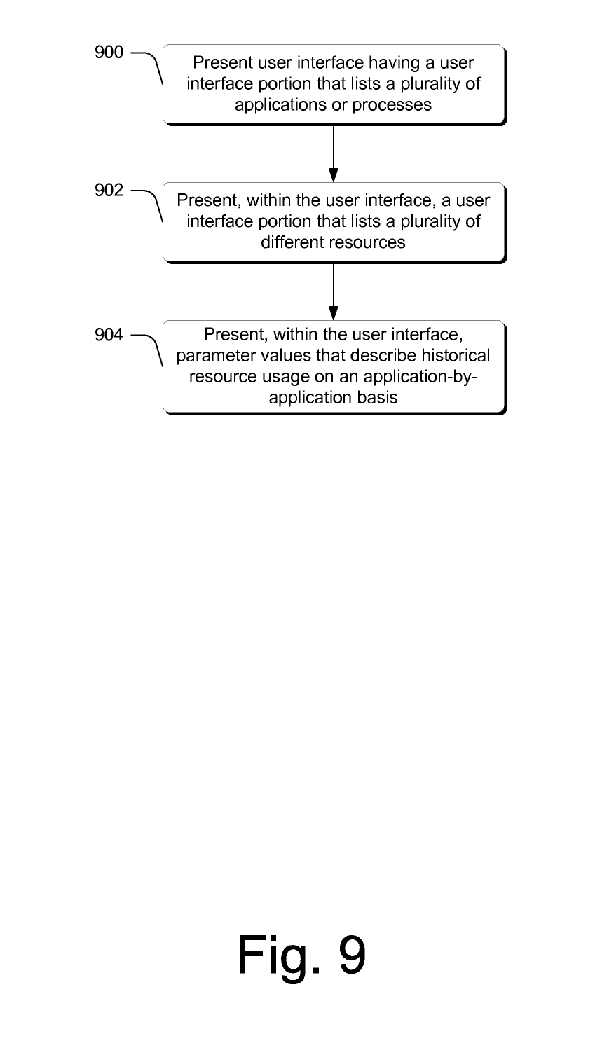

FIG. 9 is a flow diagram that describes steps in a method in accordance with one or more embodiments. The method can be performed in connection with any suitable hardware, software, firmware, or combination thereof. In at least some embodiments, the method can be performed by a suitably-configured system resource usage monitoring service 104 and resource usage monitoring user interface component 103, such as the one described above.

Step 900 presents a user interface having a user interface portion that lists a plurality of applications or processes. Examples of how this can be done are provided above. Step 902 presents, within the user interface, a user interface portion that lists a plurality of different resources. Any suitable types of resources can be listed, examples of which are provided above. Step 904 presents, within the user interface, parameter values that describe historical resource usage on an application-by-application basis. Examples of how this can be done are provided above.

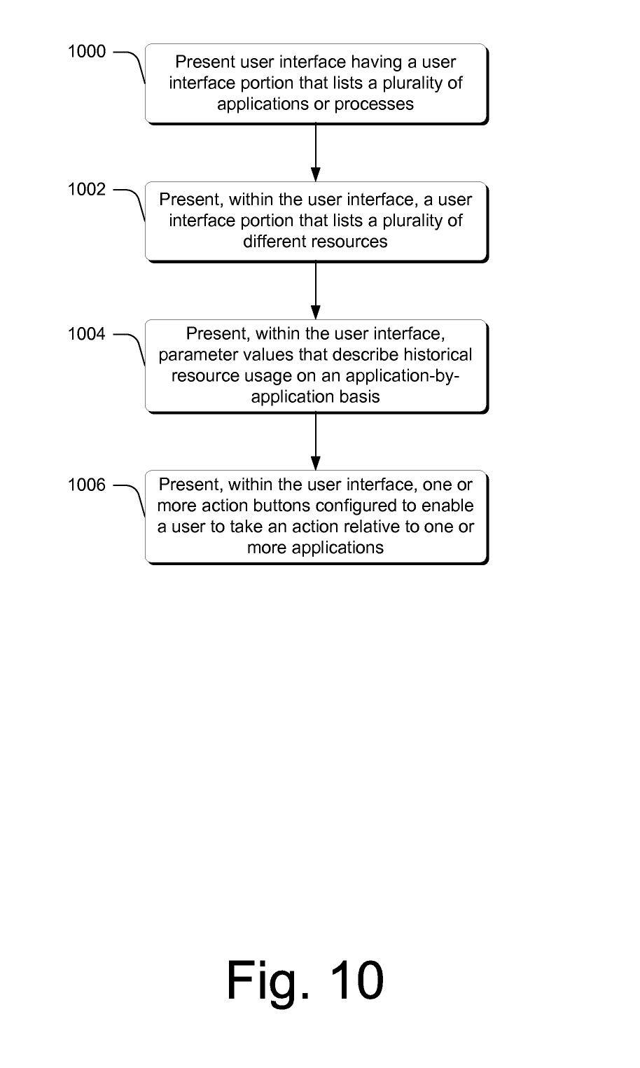

FIG. 10 is a flow diagram that describes steps in another method in accordance with one or more embodiments. The method can be performed in connection with any suitable hardware, software, firmware, or combination thereof. In at least some embodiments, the method can be performed by a suitably-configured system resource usage monitoring service 104 and resource usage monitoring user interface component 103, such as the one described above.

Step 1000 presents a user interface having a user interface portion that lists a plurality of applications or processes. Examples of how this can be done are provided above. Step 1002 presents, within the user interface, a user interface portion that lists a plurality of different resources. Any suitable types of resources can be listed, examples of which are provided above. Step 1004 presents, within the user interface, parameter values that describe historical resource usage on an application-by-application basis. Examples of how this can be done are provided above. Step 1006 presents, within the user interface, one or more action buttons configured to enable the user to take an action relative to one or more applications. Examples of actions that a user can take are provided above.

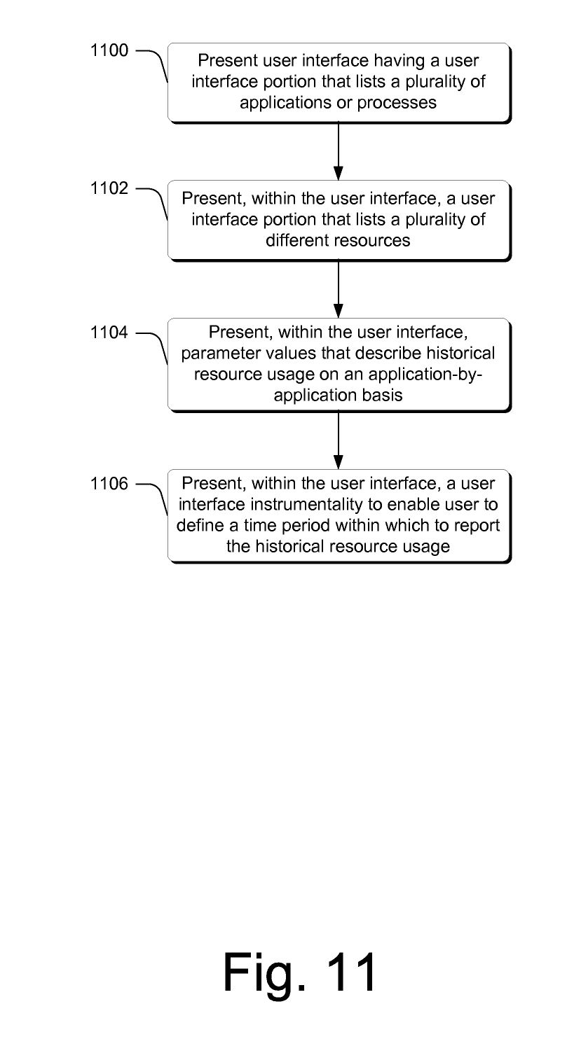

FIG. 11 is a flow diagram that describes steps in another method in accordance with one or more embodiments. The method can be performed in connection with any suitable hardware, software, firmware, or combination thereof. In at least some embodiments, the method can be performed by a suitably-configured system resource usage monitoring service 104 and resource usage monitoring user interface component 103, such as the one described above.

Step 1100 presents a user interface having a user interface portion that lists a plurality of applications or processes. Examples of how this can be done are provided above. Step 1102 presents, within the user interface, a user interface portion that lists a plurality of different resources. Any suitable types of resources can be listed, examples of which are provided above. Step 1104 presents, within the user interface, parameter values that describe historical resource usage on an application-by-application basis. Examples of how this can be done are provided above. Step 1106 presents, within the user interface, a user interface instrumentality to enable the user to define a time period within which to report the historical resource usage. Examples of how this can be done are provided above.

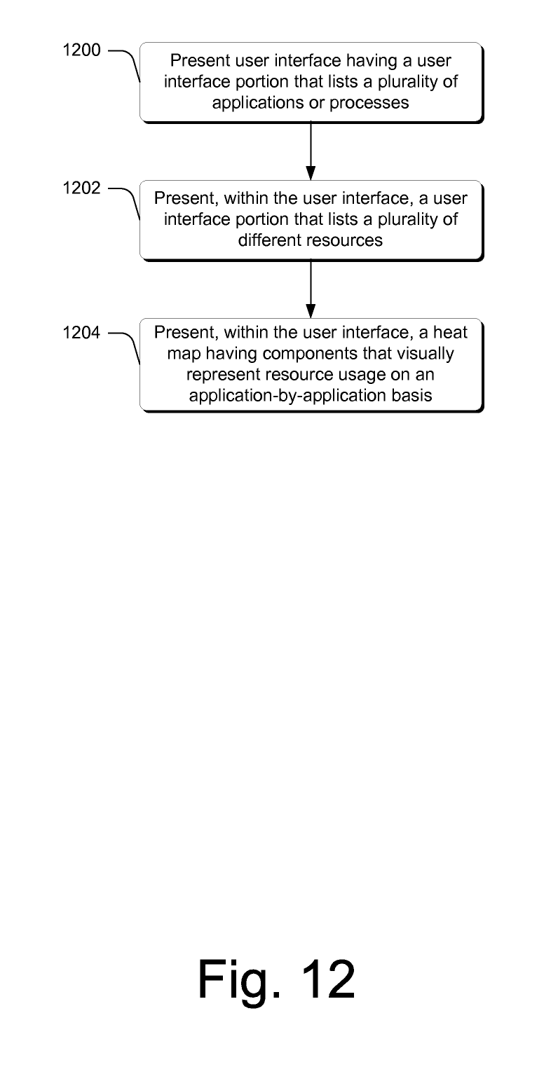

FIG. 12 is a flow diagram that describes steps in another method in accordance with one or more embodiments. The method can be performed in connection with any suitable hardware, software, firmware, or combination thereof. In at least some embodiments, the method can be performed by a suitably-configured system resource usage monitoring service 104 and resource usage monitoring user interface component 103, such as the one described above.

Step 1200 presents a user interface having a user interface portion that lists a plurality of applications or processes. Examples of how this can be done are provided above. Step 1202 presents, within the user interface, a user interface portion that lists a plurality of different resources. Any suitable types of resources can be listed, examples of which are provided above. Step 1204 presents, within the user interface, a heat map having components that visually represent resource usage on an application-by-application basis. An example heat map is shown and described above.

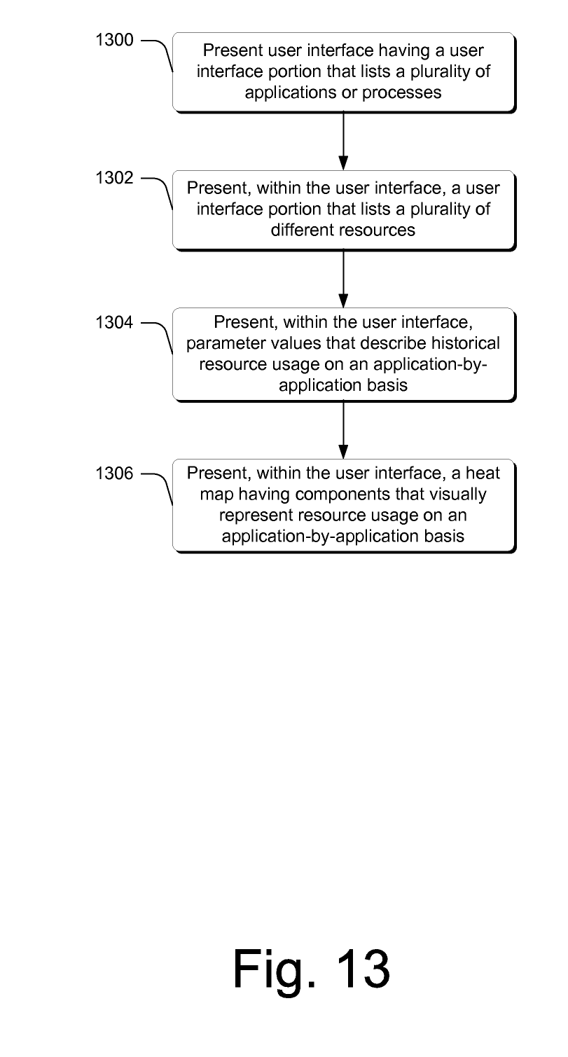

FIG. 13 is a flow diagram that describes steps in another method in accordance with one or more embodiments. The method can be performed in connection with any suitable hardware, software, firmware, or combination thereof. In at least some embodiments, the method can be performed by a suitably-configured system resource usage monitoring service 104 and resource usage monitoring user interface component 103, such as the one described above.

Step 1300 presents a user interface having a user interface portion that lists a plurality of applications or processes. Examples of how this can be done are provided above. Step 1302 presents, within the user interface, a user interface portion that lists a plurality of different resources. Any suitable types of resources can be listed, examples of which are provided above. Step 1304 presents, within the user interface, parameter values that describe historical resource usage on an application-by-application basis. Examples of how this can be done are provided above. Step 1306 presents, within the user interface, a heat map having components that visually represent resource usage on an application-by-application basis. An example heat map is shown and described above.

Example Device

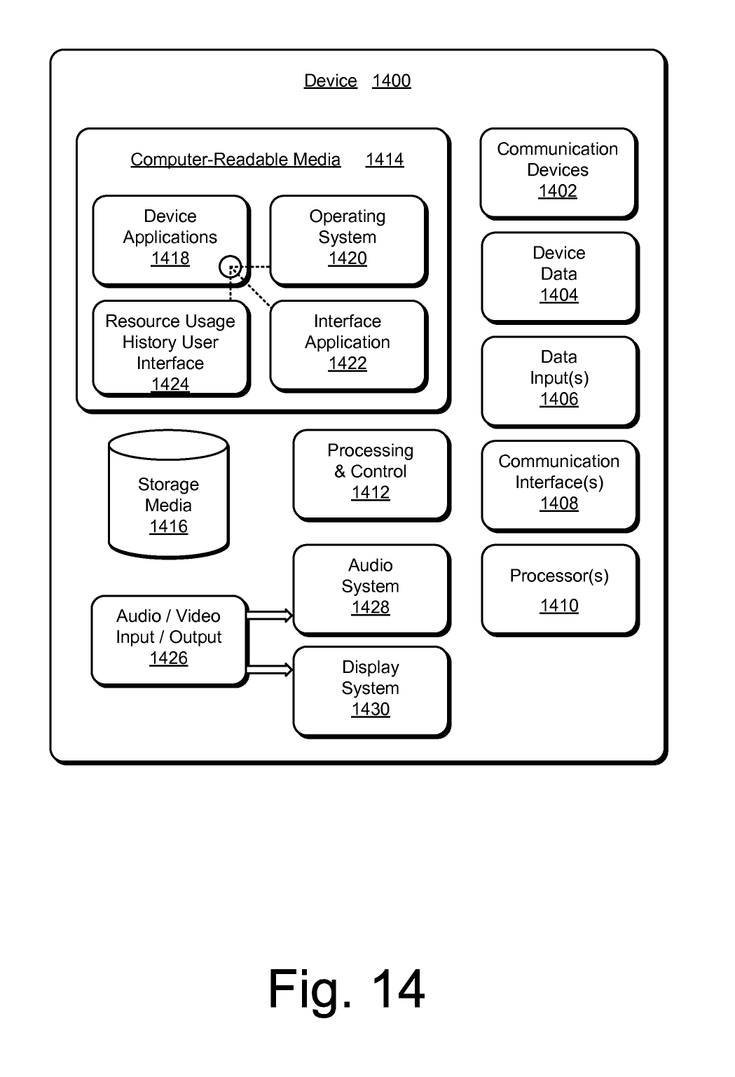

FIG. 14 illustrates various components of an example device 1400 that can be implemented as any type of portable and/or computer device as described with reference to FIGS. 1 and 2 to implement the various embodiments described above. Device 1400 includes communication devices 1402 that enable wired and/or wireless communication of device data 1404 (e.g., received data, data that is being received, data scheduled for broadcast, data packets of the data, etc.). The device data 1404 or other device content can include configuration settings of the device, media content stored on the device, and/or information associated with a user of the device. Media content stored on device 1400 can include any type of audio, video, and/or image data. Device 1400 includes one or more data inputs 1406 via which any type of data, media content, and/or inputs can be received, such as user-selectable inputs, messages, music, television media content, recorded video content, and any other type of audio, video, and/or image data received from any content and/or data source.

Device 1400 also includes communication interfaces 1408 that can be implemented as any one or more of a serial and/or parallel interface, a wireless interface, any type of network interface, a modem, and as any other type of communication interface. The communication interfaces 1408 provide a connection and/or communication links between device 1400 and a communication network by which other electronic, computing, and communication devices communicate data with device 1400.

Device 1400 includes one or more processors 1410 (e.g., any of microprocessors, controllers, and the like) which process various computer-executable or readable instructions to control the operation of device 1400 and to implement the embodiments described above. Alternatively or in addition, device 1400 can be implemented with any one or combination of hardware, firmware, or fixed logic circuitry that is implemented in connection with processing and control circuits which are generally identified at 1412. Although not shown, device 1400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1400 also includes computer-readable media 1414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1400 can also include a mass storage media device 1416.

Computer-readable media 1414 provides data storage mechanisms to store the device data 1404, as well as various device applications 1418 and any other types of information and/or data related to operational aspects of device 1400. For example, an operating system 1420 can be maintained as a computer application with the computer-readable media 1414 and executed on processors 1410. The device applications 1418 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 1418 also include any system components or modules to implement embodiments described herein. In this example, the device applications 1418 include an interface application 1422 and a resource usage history user interface component 1424 that are shown as software modules and/or computer applications. The resource usage history user interface component 1424 is representative of software that is used to provide the resource monitoring and user interface functionality described above. The interface application 1422 and the resource usage history user interface component 1424 can be implemented in connection with any suitable hardware, software, firmware, or any combination thereof.

Device 1400 also includes an audio and/or video input-output system 1426 that provides audio data to an audio system 1428 and/or provides video data to a display system 1430. The audio system 1428 and/or the display system 1430 can include any devices that process, display, and/or otherwise render audio, video, and image data. Video signals and audio signals can be communicated from device 1400 to an audio device and/or to a display device via an RF (radio frequency) link, S-video link, composite video link, component video link, DVI (digital video interface), analog audio connection, or other similar communication link. In an embodiment, the audio system 1428 and/or the display system 1430 are implemented as external components to device 1400. Alternatively, the audio system 1428 and/or the display system 1430 are implemented as integrated components of example device 1400.

### Conclusion

Various embodiments provide a user interface that displays a history of resource usage of a computing device's applications over time. Historical resource usage data can be presented in a manner which informs the user, on an application-by-application basis, of each application's resource usage across a plurality of resources. In at least some embodiments, the user interface can provide one or more instrumentalities that enable the user to interact with and/or modify operational characteristics of various applications based upon the presented historical resource usage data. Thus, having an element of control over applications can lead to efficiencies which enhance the user experience by enabling the user to control or influence, on application-by-application basis, resource consumption on their device.

In at least some embodiments, user controllability is enhanced by enabling the user to define a time window over which resource usage data can be presented.

In at least some embodiments, the user interface employs a heat map having multiple shades or colors that are used to abstract resource usage. The heat map allows for quick visual identification of resources and their particular usage on an application-by-application basis.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
presenting, on a computing device, a user interface having a user interface portion that lists a plurality of applications;
presenting, on the computing device and within the user interface, a user interface portion that lists a plurality of different resources that can be utilized by the plurality of applications; and
presenting, on the computing device and within the user interface, parameter values that describe historical resource usage on an application-by-application basis.

2. The computer-implemented method of claim 1, wherein the plurality of different resources include one or more of: download resources, power resources, CPU resources, or memory resources.

3. The computer-implemented method of claim 1, wherein at least some of the plurality of different resources are associated with network type behavior.

4. The computer-implemented method of claim 1, wherein at least some of the plurality of different resources are associated with network type behavior, at least one network type behavior comprising metered bandwidth.

5. The computer-implemented method of claim 1, wherein:
presenting the user interface having a user interface portion that lists a plurality of applications further comprises listing one or more processes or sub-components of individual applications; and
presenting parameter values that describe historical resource usage on an application-by-application basis further comprises presenting parameter values for the one or more processes or sub-components.

6. The computer-implemented method of claim 1, wherein:
presenting the user interface having a user interface portion that lists a plurality of applications further comprises listing one or more processes or sub-components of individual applications; and
presenting parameter values that describe historical resource usage on an application-by-application basis further comprises presenting parameter values for the one or more processes or sub-components,
at least some of the processes being associated with an operating system.

7. The computer-implemented method of claim 1, wherein the plurality of applications and plurality of different resources are presented in a manner that defines individual cells for individual applications and associated individual resources.

8. The computer-implemented method of claim 1, wherein at least some of the parameter values comprise character strings.

9. The computer-implemented method of claim 1, wherein at least some of the parameter values comprise visually discernible indicia other than character strings.

10. The computer-implemented method of claim 1 further comprising presenting, on the computing device and within the user interface, a user-controllable time window configured to enable the user to define a time period over which resource usage data is to be displayed.

11. One or more computer readable storage media embodying computer readable instructions which, when executed, implement a method comprising:
presenting, on a computing device, a user interface having a user interface portion that lists a plurality of applications;
presenting, on the computing device and within the user interface, a user interface portion that lists a plurality of different resources that can be utilized by the plurality of applications;
presenting, on the computing device and within the user interface, parameter values that describe historical resource usage on an application-by-application basis; and
presenting, on the computing device and within the user interface, one or more action buttons configured to enable a user to take an action relative to one or more of the applications.

12. The one or more computer readable storage media of claim 11, wherein one of the action buttons comprises an uninstall button configured to enable a user to uninstall an application.

13. The one or more computer readable storage media of claim 11, wherein one of the action buttons comprises an action button configured to enable a user to adjust an application's settings.

14. The one or more computer readable storage media of claim 11, wherein the plurality of different resources include one or more of: download resources, power resources, CPU resources, or memory resources.

15. The one or more computer readable storage media of claim 11, wherein at least some of the plurality of different resources are associated with network type behavior.

16. The one or more computer readable storage media of claim 11, wherein the computer-readable instructions, when executed, implement a method further comprising: presenting, on the computing device and within the user interface, a user-controllable time window configured to enable the user to define a time period over which resource usage data is to be displayed.

17. A computing device comprising:
one or more processors;
one or more computer readable storage media;
computer readable instructions on the one or more computer readable storage media which, when executed under the influence of the one or more processors, implement a method comprising:
presenting, on a computing device, a user interface having a user interface portion that lists a plurality of applications;
presenting, on the computing device and within the user interface, a user interface portion that lists a plurality of different resources that can be utilized by the plurality of applications;
presenting, on the computing device and within the user interface, a heat map having components that visually represent resource usage on an application-by-application basis.

18. The computing device of claim 17, computer readable instructions, when executed, implement a method further comprising presenting, within the user interface, parameter values that describe historical resource usage on an application-by-application basis.

19. The computing device of claim 17, computer readable instructions, when executed, implement a method further comprising presenting, within the user interface, one or more action buttons configured to enable a user to take action relative to one or more of the applications.

20. The computing device of claim 17, computer readable instructions, when executed, implement a method further comprising presenting, within the user interface, a user-controllable time window configured to enable the user to define a time period over which resource usage data is to be displayed.
